(19) United States
(12) Patent Application Publication
(10) Pub. No.: US 2025/0391961 A1
(43) Pub. Date: Dec. 25, 2025

(54) METHOD FOR A PROFILING SYSTEM, CLOSED PROFILE ACCORDING TO THE METHOD, AND HOUSING WITH THE CLOSED PROFILE

(71) Applicant: fischer Edelstahlrohre GmbH, Achern-Fautenbach (DE)

(72) Inventors: Mike Müller, Kappelrodeck (DE); Jérôme Maira, Seltz (FR); Marc Schweizer, Achern (DE)

(21) Appl. No.: 19/243,135

(22) Filed: Jun. 19, 2025

(30) Foreign Application Priority Data
Jun. 19, 2024 (EP) 24183235.1

(51) Int. Cl. H01M 50/103; H01M 50/169; H01M 50/171

(52) U.S. Cl. CPC H01M 50/103; H01M 50/169; H01M 50/171

(57) ABSTRACT

A method for producing a closed profile for a sealed housing for an electrical cell, the method configured to be performed by a profiling system including a profiling device, a first joining device, an embossing device, and a separating device, the method including the profiling system continuously performing steps including: roll-forming, by the profiling device, a profile metal band having a first band edge and a second band edge into a profile; material-bonded joining, by the first joining device, of the first band edge and the second band edge of the roll-formed profile to one another, whereby the profile is closed; embossing, by the embossing device, a predetermined rupture location into the profile metal band for forced venting at a bursting pressure; and cutting, by the separating device, the previously closed profile to a length, thereby producing the closed profile.

### BACKGROUND OF THE INVENTION

### Field of the Invention

The invention initially relates to a method for a profiling system for the manufacture of a closed profile for a sealed housing for an electrical cell.

The closed profile is therefore suitable for a sealed housing, and the sealed housing is suitable for an electrical cell. The housing has, for this suitability, an internal housing space, which is suitable for accommodating an electrical energy storage device. The energy storage device is, for example, an accumulator based on lithium compounds. An electrical cell thus has a housing. The housing has a closed profile and an internal housing space. The internal housing space is at least partially formed by the closed profile. An electrical energy storage device is arranged within the internal housing space.

### Description of Related Art

During operation of an electrical cell, it may occur that gas is generated within the internal housing space by the energy storage device. Gas can, for example, be generated in a lithium-based accumulator by thermal runaway. Since the housing is sealed, the gas cannot escape from the internal housing space into an external space, whereby the gas builds up a gas pressure in the internal housing space, which can damage or even destroy the cell. For example, the gas deforms the housing due to the gas pressure or even causes it to burst.

Various methods for a profiling system for continuous production of a closed profile are known from the prior art. In one known method, the profiling system comprises a profiling device and a joining device. According to the method, in one step, a profile metal band with a first band edge and a second band edge is roll-formed into a profile by the profiling device. In a further step, the first band edge and the second band edge of the profile are joined together by the joining device, whereby the profile is closed, and the closed profile is created.

It is known from the prior art to install a separate overpressure valve into such a housing, which discharges gas from the internal housing space when the gas pressure exceeds a threshold pressure. Installation takes place, for example, by welding, bonding, or pressing. The overpressure valve and its installation are associated with additional costs and process steps in the manufacture of the housing.

### SUMMARY OF THE INVENTION

An object of the present invention is to specify a method for a profiling system for the manufacture of a closed profile with an overpressure valve, which can be manufactured more cost-effectively than in the prior art or at least represents an alternative.

The object is achieved by a first method for a profiling system that comprises an embossing device, a first punching device, a first joining device, a second joining device, a profiling device, and a cutting device, and wherein the profiling system continuously performs the following steps.
In one step, a predetermined rupture point is embossed into a rupture metal band by the embossing device for forced venting at a burst pressure. At the predetermined rupture point, a thickness of the rupture metal band is smaller than a thickness of the rupture metal band outside the predetermined rupture point, so that the rupture metal band is mechanically weakened at the predetermined rupture point. When a gas exerts a gas pressure on the predetermined rupture point and the gas pressure reaches a bursting gas pressure, the predetermined rupture point bursts so that the gas escapes. In this sense, the predetermined rupture point is an overpressure valve.
In a further step, an opening is punched into a profile metal band with a first band edge and a second band edge by the first punching device, fitting to the predetermined rupture point. The first and second band edges are opposite each other. “Fitting” here means that the opening in the profile metal band does not prevent the bursting of the predetermined rupture point.
In a further step, the profile metal band and the rupture metal band are joined by material-bonding on top of one another by the second joining device, so that the predetermined rupture point and the opening in the profile metal band fit each other. “Fitting” here means that the gas can escape through the burst predetermined rupture point and the opening in the profile metal band.
In a further step, the profile metal band is roll-formed into a profile by the profiling device. Preferably, the embossing of the predetermined rupture point takes place before roll-forming the profile. Roll-forming is a continuous production of profiles like this.
In a further step, the first band edge and the second band edge of the roll-formed profile are joined by material-bonding to each other by the first joining device, whereby the profile is closed.
In a further step, the previously closed profile is cut to length by the cutting device, thereby producing the closed profile. The cutting device is preferably a flying cutting device.

The above steps describe the manufacture of one piece, i.e., one closed profile. The steps of the method are executed, for example, in the order listed. Since the method is executed continuously, which in particular also includes the continuous feeding of the metal bands, a plurality of closed profiles are produced. The metal bands are the rupture metal band and the profile metal band.

When in an electrical cell with a sealed housing comprising the closed profile, gas builds up a gas pressure in the internal housing space and the gas pressure reaches the bursting gas pressure, then the predetermined rupture point bursts and the gas escapes from the internal housing space into an external space.

The method described above is based on the insight that the closed profile of a sealed housing is particularly well-suited for cost-effective manufacturing of an overpressure valve.

Embodiments according to the first method described above provide an efficient and cost-effective method for producing a closed profile for a sealed housing with an overpressure valve for an electrical cell in comparison to the prior art. The method is also faster than that known from the prior art.

Since the steps of the method are executed continuously, the rupture metal band and the profile metal band are also continuously fed. For this purpose, the profiling system preferably comprises a first uncoiler with a coil of the rupture metal band and a second uncoiler with a coil of the profile metal band.

Preferably, the profiling system comprises a first band storage device, and the rupture metal band is temporarily stored therein to ensure the continuous execution of the method even when equipping the first uncoiler with a new coil of the rupture metal band. Preferably, the profiling system also comprises a second band storage device, and the profile metal band is temporarily stored therein to ensure the continuous execution of the method even when equipping the second uncoiler with a new coil of the profile metal band.

Preferably, the profiling system comprises a first band straightening device, and the rupture metal band is straightened therein. Preferably, the profiling system comprises a second band straightening device, and the profile metal band is straightened therein. A metal band, such as the rupture metal band and the profile metal band, after uncoiling from a coil, has various waves and internal mechanical stresses that may cause deviations after roll-forming. These waves and stresses are eliminated in a band straightening device by multiple bending in opposite directions.

In one embodiment, the second joining device employs a laser welding method or an adhesive bonding method for integral joining. Preferably, the joining in the laser welding method takes place without filler materials.

The object is also achieved by a second method for a profiling system that comprises a profiling device, a first joining device, an embossing device, and a separating device, wherein the profiling system continuously performs the following steps.
In one step, a profile metal band with a first band edge and a second band edge is roll-formed into a profile by the profiling device.
In a further step, the first band edge and the second band edge of the roll-formed profile are joined by material-bonding to each other by the first joining device, whereby the profile is closed.
In a further step, a predetermined rupture point is embossed into the profile metal band for forced venting at a burst pressure by the embossing device.
In a further step, the previously closed profile is cut to length by the separating device, thereby producing the closed profile.

Embodiments according to the second method described above provide an efficient and cost-effective method for producing a closed profile for a sealed housing with an overpressure valve for an electrical cell in comparison to the prior art. Compared to the previously described first method, this second method is simpler and faster and thus more cost-effective, particularly because of the omission of the rupture metal band, but also more limited. For while in the first method the rupture metal band can be selected exclusively for its suitability for bursting, in the second method the profile metal band must be selected both for its bursting properties and for its suitability for forming the profile. The steps of the method are executed, for example, in the order listed. Otherwise, the statements for the first method apply correspondingly to the second method and vice versa.

In one design of the method, the embossing of the predetermined rupture point into the profile metal band is carried out after the joining by material-bonding.

In one design, the embossing of the predetermined rupture point into the profile metal band is carried out after cutting the closed profile to length.

Alternatively, the order of the last and second to last steps is reversed.

In a further design, a metal band having a thickness between 0.05 mm and 1 mm and preferably a width between 8 mm and 50 mm is used as the rupture metal band.

In a further design, a metal band having a thickness between 0.2 mm and 2 mm, preferably between 0.3 mm and 0.8 mm, and preferably with a width of more than 100 mm is used as the profile metal band. The width corresponds to a distance between the first band edge and the second band edge.

In a further design, at least one of the metal bands consists of aluminum, steel, or stainless steel. For example, it is a nickel- or aluminum-plated steel.

In a further design, the first joining device employs a laser welding method or an adhesive bonding method for material-bonded joining. Preferably, the joining in the laser welding method takes place without filler materials.

In a further design, the embossing of the predetermined rupture point is performed on an outside surface. The outside surface borders the external space.

In a further design, the burst pressure is set by a depth of the embossing of the predetermined rupture point.

In a further design, the embossing of the predetermined rupture point has the shape of a line. The line may have various alternative configurations.

In a first of the alternative configurations, the line bifurcates at both ends. This shape results in a particularly large opening upon bursting, through which the gas can escape especially quickly.

In a second of the alternative configurations, the line has the shape of two isosceles trapezoids. The isosceles trapezoids have a longer and a shorter base side and share the shorter base side.

In a third of the alternative configurations, the line is divided into a first, second, third, fourth, and fifth segment. Thus, the second segment adjoins the first, the third adjoins the second, the fourth adjoins the third, and the fifth adjoins the fourth segment. The first segment, the third segment, and the fifth segment are straight. The second segment and the fourth segment are curved. The first segment and the fifth segment are parallel and opposite to each other. The third segment lies between the first segment and the fifth segment. The third segment and the first segment span an angle. The third segment and the fifth segment also span this angle. Consequently, the third segment is diagonal with respect to the first segment and the fifth segment. The ends of the line are free.

In a further design, the closed profile has a prismatic, preferably rectangular, shape. Preferably, it has a width between 20 mm and 60 mm and a height between 100 mm and 150 mm. A cylindrical shape, preferably with a circular cross-section, is also possible.

In a further design, the length of the closed profile lies between 200 mm and 1500 mm. Preferably, a dry cutting blade is used by the cutting device for cutting to length. This results in minimal contamination and burr-free cut edges.

The closed profile has a first and a second open end, which are opposite each other, and is used in the manufacture of the sealed housing and thus also in the manufacture of an electrical cell. During the manufacture of the electrical cell and thus also of the sealed housing, an electrical energy storage device is arranged in the internal housing space, and the first and second open ends are sealed. Sealing is carried out, for example, with metal sheets made of the same material as the profile metal band. The metal sheets and the closed profile are, for example, joined by material-bonding at the first and second open ends by a laser welding method.

The object is also achieved by a closed profile that is produced according to one of the previously described methods.

The object is also achieved by a sealed housing for an electrical cell, the sealed housing being characterized in that it comprises the previously described closed profile.

The explanations for the methods apply accordingly to the closed profile and also to the sealed housing.

In detail, there are numerous possibilities for designing and further developing the methods, the closed profile, and the sealed housing. For this purpose, reference is made to the following description of preferred embodiments in connection with the accompanying drawings.

### BRIEF DESCRIPTION OF THE DRAWINGS

FIG. 1 shows components of a first profiling system in accordance with aspects of the present disclosure.

FIG. 2 shows a flow chart of a first method for the first profiling system for manufacturing a first closed profile in accordance with aspects of the present disclosure.

FIG. 3 shows a visualization of steps of the first method in accordance with aspects of the present disclosure.

FIG. 4 shows a longitudinal section in accordance with aspects of the present disclosure.

FIG. 5 shows a depiction of the first closed profile in accordance with aspects of the present disclosure.

FIG. 6 shows components of a second profiling system in accordance with aspects of the present disclosure.

FIG. 7 shows a flow chart of a second method for the second profiling system for manufacturing a second closed profile in accordance with aspects of the present disclosure.

FIG. 8 shows a depiction of the second closed profile in accordance with aspects of the present disclosure.

FIG. 9 shows a depiction of a sealed housing in accordance with aspects of the present disclosure.

FIG. 10 shows a first alternative of a predetermined rupture point in accordance with aspects of the present disclosure.

FIG. 11 shows a second alternative of a predetermined rupture point in accordance with aspects of the present disclosure.

### DETAILED DESCRIPTION OF THE INVENTION

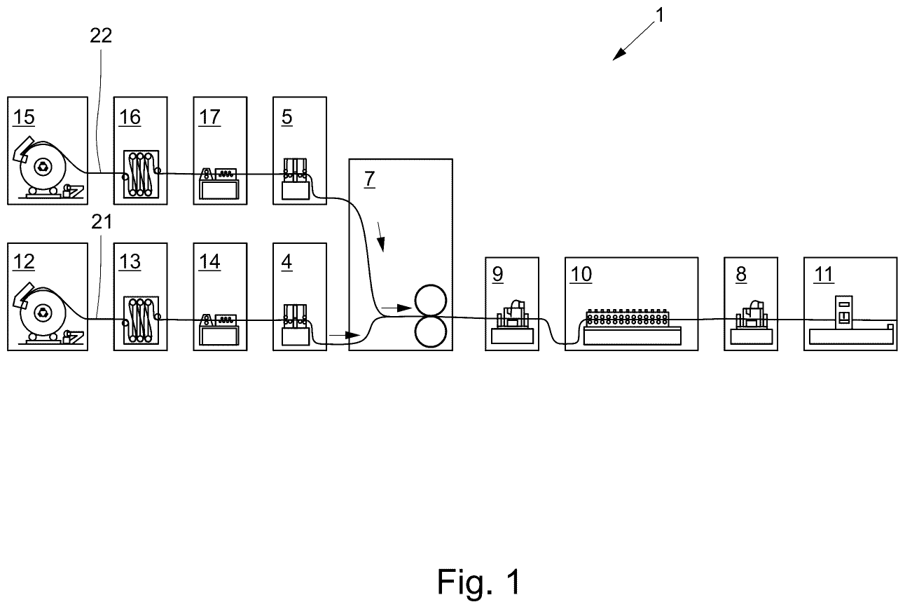

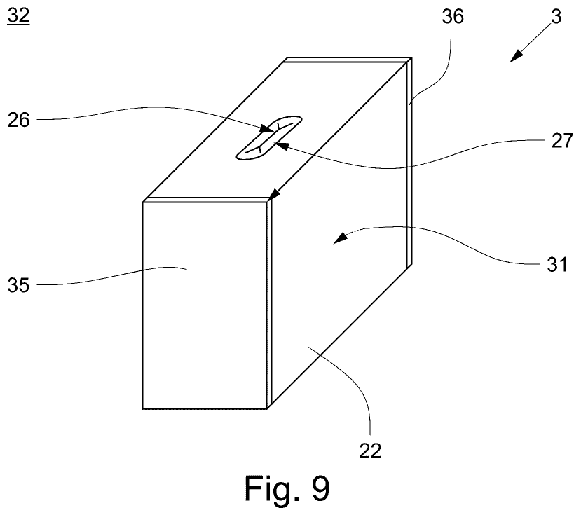

FIG. 1 shows components of a first profiling system 1 in an abstract and symbolic manner. It is designed for manufacturing a first closed profile 2 (see FIG. 5) for a sealed housing 3 (see FIG. 9) for an electrical cell. For this purpose, it comprises an embossing device 4, a first punching device 5, a guiding device 7, a first joining device 8, a second joining device 9, a profiling device 10, and a flying cutting device 11.

Furthermore, the first profiling system 1 comprises a first uncoiler 12, a first band storage device 13, a first band straightening device 14, a second uncoiler 15, a second band storage device 16, and a second band straightening device 17.

The first profiling system 1 is in operation. Therefore, the first uncoiler 12 is equipped with a rupture metal band 21, which is first fed to the first band storage device 13 and then to the first band straightening device 14. It has a width of approximately 20 mm and a thickness of approximately 0.4 mm. Furthermore, the second uncoiler 15 is equipped with a profile metal band 22, which is first fed to the second band storage device 16 and then to the second band straightening device 17. It has a width of approximately 260 mm and a thickness of approximately 0.6 mm. The rupture metal band 21 and the profile metal band 22 are metal bands made of aluminum. The profile metal band 22 has a first band edge 24 and a second band edge 25, which are parallel to each other and have a distance from each other corresponding to the width, i.e., approximately 260 mm. The uncoilers, the band storage devices, and the band straightening devices are identically designed but adjusted to the respective metal band.

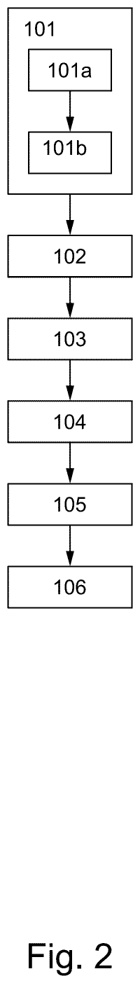

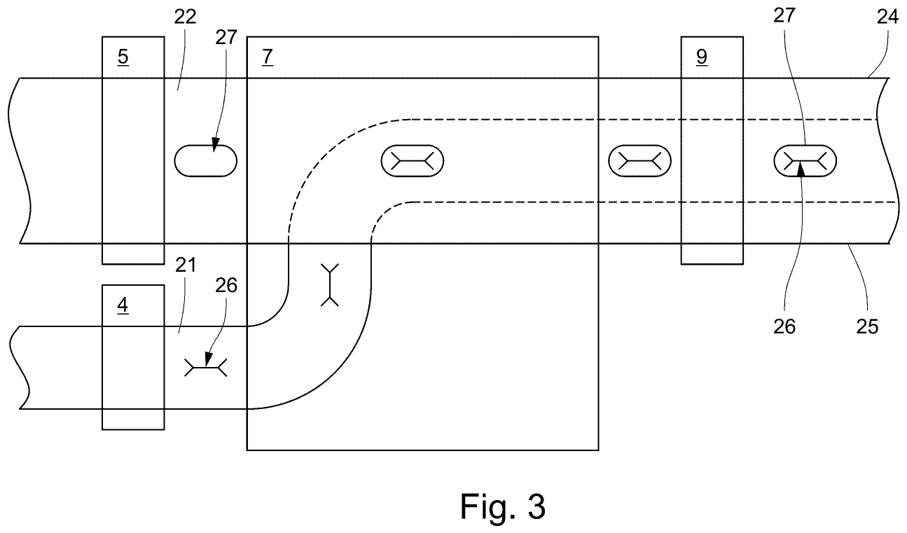

The first profiling system 1 continuously carries out, with the straightened rupture metal band 21 and the straightened profile metal band 22, a first method described below for manufacturing the first closed profile 2 for the sealed housing 3 for an electrical cell. FIG. 2 shows a flow chart with the steps of the first method and FIG. 3 visualizes steps of the first method in an abstract and symbolic manner.

In a first step 101, the following substeps are carried out simultaneously:

In a first substep 101a of the first step 101, a predetermined rupture point 26 is embossed into the rupture metal band 21 by the embossing device 4 for forced venting at a burst pressure. The predetermined rupture point 26 has the shape of a line, whereby the line bifurcates at both ends. The burst pressure is set by a depth of the embossing of the predetermined rupture point 26. When a gas exerts a gas pressure on the predetermined rupture point 26 and the gas pressure reaches a bursting gas pressure, the predetermined rupture point 26 bursts so that the gas escapes.

In a second substep 101b, an opening 27 is punched into the profile metal band 22 by the first punching device 5, fitting to the predetermined rupture point 26.

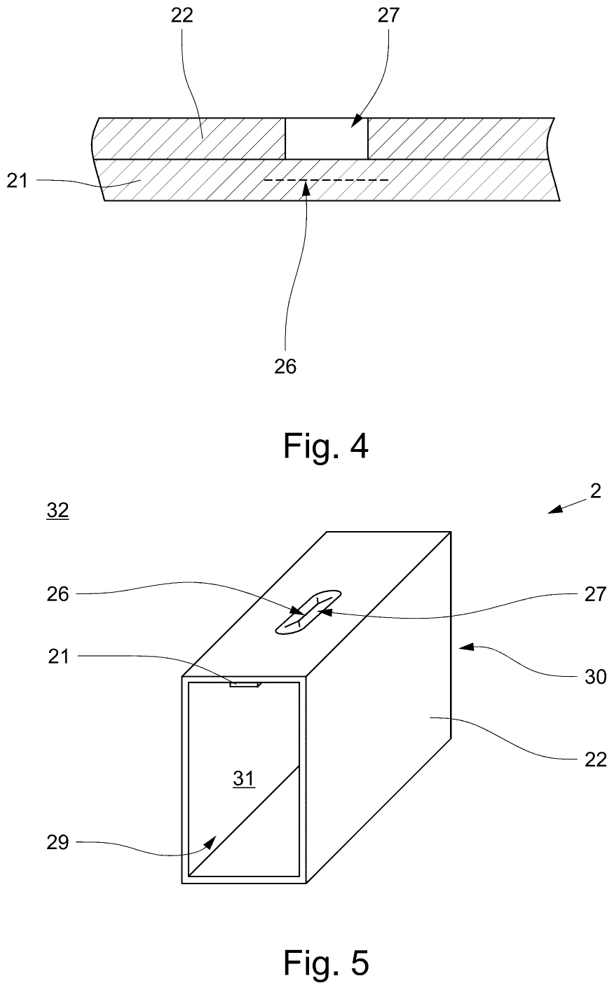

In a second step 102, the rupture metal band 21 with the embossed predetermined rupture point 26 and the profile metal band 22 with the punched opening 27 are brought together by the guiding device 7 in such a way that the opening 27 in the profile metal band 22 is arranged to fit around the predetermined rupture point 26 in the rupture metal band 21. This is understood as “fitting.” FIG. 4 shows a longitudinal section in which the fitting arrangement of the metal bands is shown. In other words, the opening 27 of the profile metal band 22 is arranged above the predetermined rupture point 26 of the rupture metal band 21.

In a third step 103, the rupture metal band 21 and the profile metal band 22 are joined by material-bonding on top of one another by the second joining device 9, so that the predetermined rupture point 26 and the opening 27 in the profile metal band 22 fit to each other. A laser welding method is employed by the second joining device 9 for material-bonded joining.

In a fourth step 104, the profile metal band 22 is roll-formed into a profile by the profiling device 10. In general, the profile has a prismatic shape. Here, it is a rectangular shape.

In a fifth step 105, the first band edge 24 and the second band edge 25 of the profile metal band 22 are joined by material bonding to each other by the first joining device 8, whereby the roll-formed profile is closed. A laser welding method is also employed by the first joining device 8 for material-bonded joining.

In a sixth step 106, the previously closed profile is cut to length by the flying cutting device 11, thereby producing the first closed profile 2 (see FIG. 5). The length is 200 mm.

The above steps describe the production of one piece of the first closed profile 2. Since the method is executed continuously, which particularly includes the continuous feeding of the metal bands, a plurality of the first closed profiles 2 is produced.

FIG. 5 shows the first closed profile 2 schematically and symbolically in a perspective view. It has a rectangular shape with a width of approximately 30 mm and a height of approximately 100 mm. The circumference is therefore approximately 260 mm, which corresponds to the width of the profile metal band 22. Finally, it has a length of 200 mm.

The first closed profile 2 has a first open end 29 and a second open end 30, which are opposite each other. The first closed profile 2 forms a part of an internal housing space 31 of the sealed housing 3. The rupture metal band 21 is arranged on one side of the profile metal band 22, which faces the internal housing space 31. The other side of the profile metal band 22 faces an external space 32.

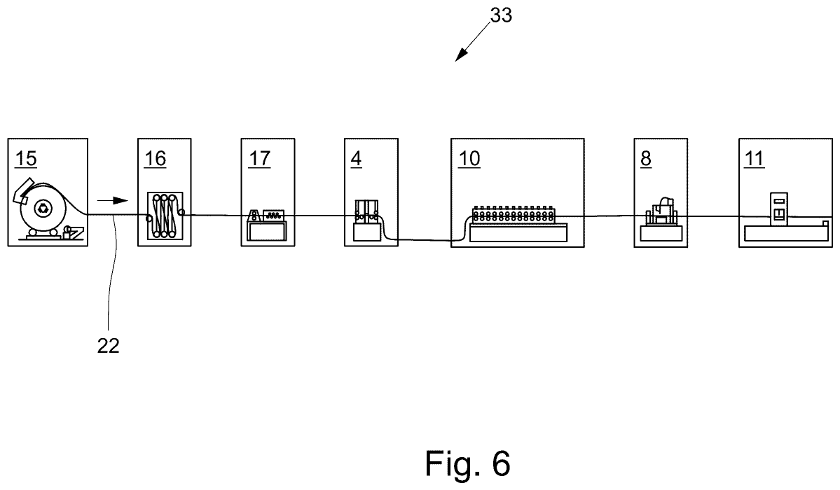

FIG. 6 shows components of a second profiling system 33. It is designed for manufacturing a second closed profile 34 for the sealed housing 3. For this purpose, it comprises a profiling device 10, a first joining device 8, an embossing device 4, and a flying cutting device 11.

Furthermore, the second profiling system 33 comprises a second uncoiler 15, a second band storage device 16, and a second band straightening device 17.

The second profiling system 33 is also in operation. Therefore, the second uncoiler 15 is equipped with a profile metal band 22, which is first fed to the second band storage device 16 and then to the second band straightening device 17. It has a width of approximately 260 mm and a thickness of 0.6 mm. The profile metal band 22 has a first band edge 24 and a second band edge 25, which are parallel to each other and have a distance from each other corresponding to the width, i.e., 260 mm.

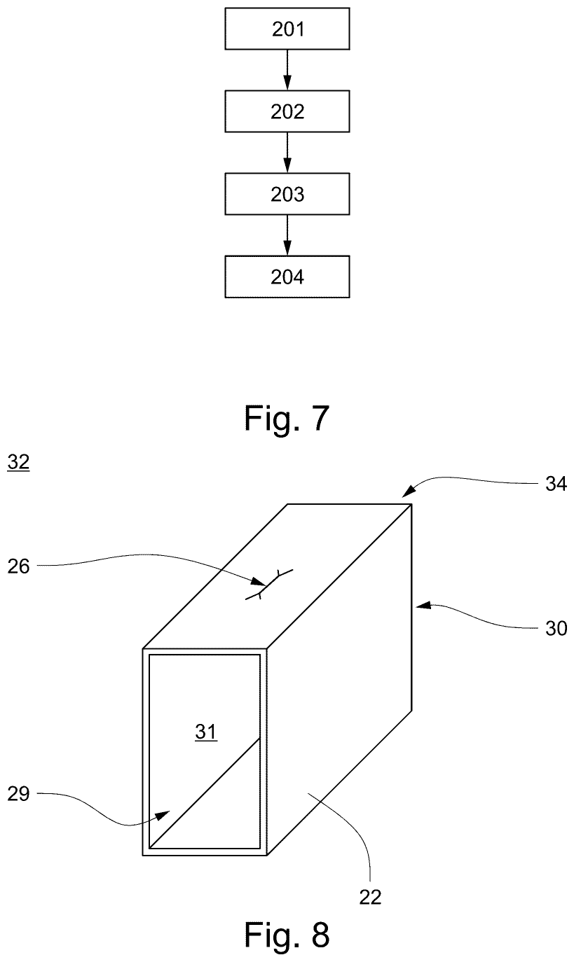

The second profiling system 33 continuously carries out, with the straightened profile metal band 22, a second method described below for manufacturing the second closed profile 34 for the sealed housing 3. FIG. 7 shows a flow chart with the steps of the second method.

In a first step 201, a predetermined rupture point 26 is embossed into the profile metal band 22 for forced venting at a burst pressure by the embossing device 4. The predetermined rupture point 26 has the shape of a line, whereby the line bifurcates at both ends. The burst pressure is set by a depth of the embossing of the predetermined rupture point 26.

In a second step 202, the profile metal band 22 is roll-formed into a profile by the profiling device 10. In general, the profile has a prismatic shape. Here, it is a rectangular shape.

In a third step 203, the first band edge 24 and the second band edge 25 of the profile metal band 22 are joined by material bonding to each other by the first joining device 8, whereby the roll-formed profile is closed.

In a fourth step 204, the previously closed profile is cut to length by the flying cutting device 11, thereby producing the second closed profile 34 (see FIG. 8). The length is 200 mm.

FIG. 8 shows the second closed profile 34 schematically and symbolically in a perspective view. It has a rectangular shape with a width of approximately 30 mm and a height of approximately 100 mm. The circumference is therefore approximately 260 mm, which corresponds to the width of the profile metal band 22. Finally, it has a length of 200 mm. The second closed profile 34 also has a first open end 29 and a second open end 30, which are opposite each other.

Otherwise, the statements for the first method and the first profiling system 1 apply correspondingly to the second method and the second profiling system 33.

FIG. 9 shows the sealed housing 3 for an electrical cell schematically and symbolically in a perspective view. In this embodiment, it comprises the first closed profile 2. Additionally, the sealed housing 3 further comprises a first metal plate 35 fitting onto the first open end 29 and a second metal plate 36 fitting onto the second open end 30. They are made of the same material as the profile metal band 22. The first metal plate 35 is connected by material bonding to the profile metal band 22 at the first open end 29, and the second metal plate 36 is connected by material bonding to the profile metal band 22 at the second open end 30. A laser welding method is used for material-bonded sealing.

When gas builds up a gas pressure within the internal housing space 31 and the gas pressure reaches the bursting gas pressure, the predetermined rupture point 26 bursts and the gas escapes from the internal housing space 31 into the external space 32.

In another embodiment, the sealed housing 3 comprises, instead of the first closed profile 2, the second closed profile 34. The statements for the embodiment with the first closed profile 2 apply correspondingly.

The line of the predetermined rupture point 26 may also have alternative forms.

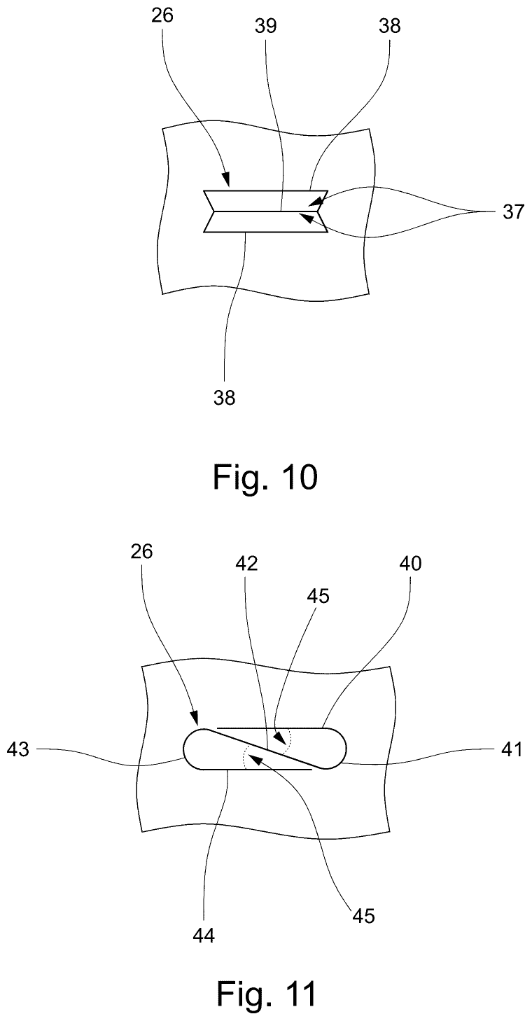

FIG. 10 shows a first alternative. In this, the line has the shape of two isosceles trapezoids 37. The isosceles trapezoids 37 have a longer base side 38 and a shorter base side 39, with the shorter base sides 39 coinciding.

FIG. 11 shows a second alternative. In this, the line is divided into a first segment 40, second segment 41, third segment 42, fourth segment 43, and fifth segment 44. It is apparent that the second segment 41 adjoins the first segment 40, the third segment 42 adjoins the second segment 41, the fourth segment 43 adjoins the third segment 42, and the fifth segment 44 adjoins the fourth segment 43. The first segment 40, the third segment 42, and the fifth segment 44 are straight. The second segment 41 and the fourth segment 43 are curved. The first segment 40 and the fifth segment 44 are parallel to and opposite each other. The third segment 42 lies between the first segment 40 and the fifth segment 44. The third segment 42 and the first segment 40 span an angle 45. The third segment 42 and the fifth segment 44 also span this angle 45. The angles 45 are indicated by curved dashed lines. Consequently, the third segment 42 is diagonal with respect to the first segment 40 and the fifth segment 44. The ends of the line are free. The line is therefore not closed.

### Reference Numbers

1 First profiling system
2 First closed profile
3 Sealed housing
4 Embossing device
5 First punching device
7 Guiding device
8 First joining device
9 Second joining device
10 Profiling device
11 Flying cutting device
12 First uncoiler
13 First band storage device
14 First band straightening device
15 Second uncoiler
16 Second band storage device
17 Second band straightening device
21 Rupture metal band
22 Profile metal band
24 First band edge
25 Second band edge
26 Predetermined rupture point
27 Opening in profile metal band
29 First open end of a closed profile
30 Second open end of a closed profile
31 Internal housing space
32 External space
33 Second profiling system
34 Second closed profile
35 First metal plate
36 Second metal plate
37 Trapezoid
38 Longer base side of the trapezoid
39 Shorter base side of the trapezoid
40 First segment
41 Second segment
42 Third segment
43 Fourth segment
44 Fifth segment
45 Angle

What is claimed is:

1. A method for producing a closed profile for a sealed housing for an electrical cell, the method configured to be performed by a profiling system comprising an embossing device, a first punching device, a first joining device, a second joining device, a profiling device, and a separating device, the method comprising the profiling system continuously performing steps including:
embossing, by the embossing device, a predetermined rupture location into a rupture metal band for forced venting at a bursting pressure;
punching, by the first punching device, an opening corresponding to the predetermined rupture location into a profile metal band having a first band edge and a second band edge;
material-bonded joining, by the second joining device, of the profile metal band and the rupture metal band on top of one another, such that the predetermined rupture location and the opening in the profile metal band are aligned with one another;
roll-forming, by the profiling device, the profile metal band into a profile;
material-bonded joining, by the first joining device, of the first band edge and the second band edge of the roll-formed profile to one another, whereby the profile is closed; and
cutting, by the separating device, the previously closed profile to a length, thereby producing the closed profile.

2. The method according to claim 1, wherein a laser welding process or an adhesive bonding process is performed by the second joining device for material-bonded joining.

3. A method for producing a closed profile for a sealed housing for an electrical cell, the method configured to be performed by a profiling system comprising a profiling device, a first joining device, an embossing device, and a separating device, the method comprising the profiling system continuously performing steps including:
roll-forming, by the profiling device, a profile metal band having a first band edge and a second band edge into a profile;
material-bonded joining, by the first joining device, of the first band edge and the second band edge of the roll-formed profile to one another, whereby the profile is closed;
embossing, by the embossing device, a predetermined rupture location into the profile metal band for forced venting at a bursting pressure; and
cutting, by the separating device, the previously closed profile to a length, thereby producing the closed profile.

4. The method according to claim 3, wherein the embossing of the predetermined rupture location is performed after the material-bonded joining.

5. The method according to claim 3, wherein the embossing of the predetermined rupture location into the profile metal band is performed after cutting the closed profile to length.

6. The method according to claim 1, wherein a metal band having a thickness between 0.05 mm and 1 mm and a width between 8 mm and 50 mm is used as the rupture metal band.

7. The method according to claim 1, wherein a metal band having a thickness between 0.2 mm and 2 mm and a width of more than 100 mm is used as the profile metal band.

8. The method according to claim 1, wherein a metal band having a thickness between 0.3 mm and 0.8 mm and a width of more than 100 mm is used as the profile metal band.

9. The method according to claim 6, wherein at least one of the metal bands consists of aluminum, steel, or stainless steel.

10. The method according to claim 1, wherein a laser welding process or an adhesive bonding process is performed by the first joining device for material-bonded joining.

11. The method according to claim 1, wherein the embossing of the predetermined rupture location is performed on an outer side.

12. The method according to claim 1, wherein the bursting pressure is set by a depth of the embossing of the predetermined rupture location.

13. The method according to claim 1, wherein the embossing of the predetermined rupture location has the shape of a line according to one of the following:
the line bifurcates at both ends;
the line has the shape of two isosceles trapezoids, wherein the isosceles trapezoids have a longer base and a shorter base, and the shorter bases coincide; or
the line is divided into a first segment, a second segment, a third segment, a fourth segment, and a fifth segment, wherein the first segment, third segment, and fifth segment are straight, and the second segment and fourth segment are curved, wherein the first segment and the fifth segment are parallel to one another and opposite each other, wherein the third segment lies between the first segment and the fifth segment, wherein the third segment and the first segment span an angle, wherein the third segment and the fifth segment also span this angle, and wherein the ends of the line are free.

14. The method according to claim 1, wherein the closed profile has a prismatic shape and a width between 20 mm and 60 mm and a height between 100 mm and 150 mm.

15. The method according to claim 1, wherein the closed profile has a rectangular shape and a width between 20 mm and 60 mm and a height between 100 mm and 150 mm.

16. The method according to claim 1, wherein the length of the closed profile lies between 200 mm and 1500 mm.

17. A closed profile produced according to the method of claim 1.

18. A closed profile produced according to the method of claim 3.

19. A sealed housing for an electrical cell, wherein the sealed housing comprises the closed profile according to claim 17.

20. A sealed housing for an electrical cell, wherein the sealed housing comprises the closed profile according to claim 18.
